(19) United States
(12) Patent Application Publication
(10) Pub. No.: US 2013/0086399 A1
(43) Pub. Date: Apr. 4, 2013

(54) METHOD, SYSTEM AND APPARATUS FOR NETWORK POWER MANAGEMENT

(71) Applicants: Emmanuel Tychon, Angleur (BE); John Monaghan, Dunbartonshire (GB)

(72) Inventors: Emmanuel Tychon, Angleur (BE); John Monaghan, Dunbartonshire (GB)

(73) Assignee: Cisco Technology, Inc., San Jose, CA (US)

(21) Appl. No.: 13/249,850

(22) Filed: Sep. 30, 2011

(51) Int. Cl. G06F 1/28; G06F 1/32

(52) U.S. Cl. 713/320; 713/340

(57) ABSTRACT

A method for receiving Internet Protocol (IP) IP traffic data corresponding to one or more network devices, analyzing the IP traffic data and dynamically generating a power management policy based on the analysis.

### TECHNICAL FIELD

Methods and devices for power management in an enterprise network.

### BACKGROUND

Currently, power management in enterprise networks is dependent on static power management policies to reduce power consumption. Static power management policies lose efficiency when activity in a network changes or varies over time.

### BRIEF DESCRIPTION OF THE DRAWINGS

FIG. 1 depicts a system for managing power use in an enterprise network.

FIG. 2 is a block diagram illustrating an example embodiment of a method for monitoring Internet Protocol (IP) IP traffic.

FIG. 3 is a flow diagram showing a process for categorizing IP traffic data.

FIG. 4 depicts a system for managing power use in an enterprise network.

FIG. 5 depicts a system for managing power use in an enterprise network.

FIG. 6 is a flow diagram showing a process for generating a dynamic power management policy.

### DESCRIPTION OF EXAMPLE EMBODIMENTS

Overview

In an example embodiment, a policy builder is configured for receiving Internet Protocol (IP) IP traffic data corresponding to one or more network devices, analyzing the IP traffic data and dynamically generating a power management policy based on the analysis.

Several examples of the present application will now be described with reference to the accompanying drawings. Various other examples of the disclosed technology are also possible and practical. This application may be exemplified in many different forms and should not be construed as being limited to the examples set forth herein. The figures listed above illustrate various examples of the application and the operation of such examples. In the figures, the size of the boxes is not intended to represent the size of the various physical components. Only those parts of the various units are shown and described which are necessary to convey an understanding of the examples to those skilled in the art.

Additional aspects and advantages will be apparent from the following detailed description of example embodiments. The illustrated example embodiments and features are offered by way of example and not limitation. Furthermore, the described features, structures, or characteristics may be combined in any suitable manner in one or more example embodiments.

In general, the methodologies of the present disclosed technology may be carried out using one or more digital processors, for example the types of microprocessors that are commonly found in PC's, servers, laptops, Personal Data Assistants (PDAs) and all manner of desktop or portable electronic appliances.

In the following description, certain specific details of programming, software modules, user selections, network transactions, database queries, database structures, etc., are provided for a thorough understanding of the example embodiments of the disclosed technology. However, those skilled in the art will recognize that the disclosed technology can be practiced without one or more of the specific details, or with other methods, components, materials, etc.

### Example Embodiments

System

The disclosed technology provides an objective, measurable and reproducible method to create power management policies for Internet Protocol (IP) enabled devices such as personal computers (PCs), servers, routers, switches, phones, access-points and so on. This network centric approach, using the network as a platform to define efficient and realistic power management policies may be responsive to analysis of network activity as detected by native network intelligence systems such as deep-packet-inspection and IP traffic flow analysis.

In a network, energy expenditures to power devices either simply left in an on state and not being used or being used for unauthorized purposes is wasteful. Devices that are IP enabled may generate IP traffic. The IP traffic may be monitored. Observed IP traffic data may be used to implement current power management policies, modify existing power management policies and/or dynamically generate new power management policies to regulate power usage in the network.

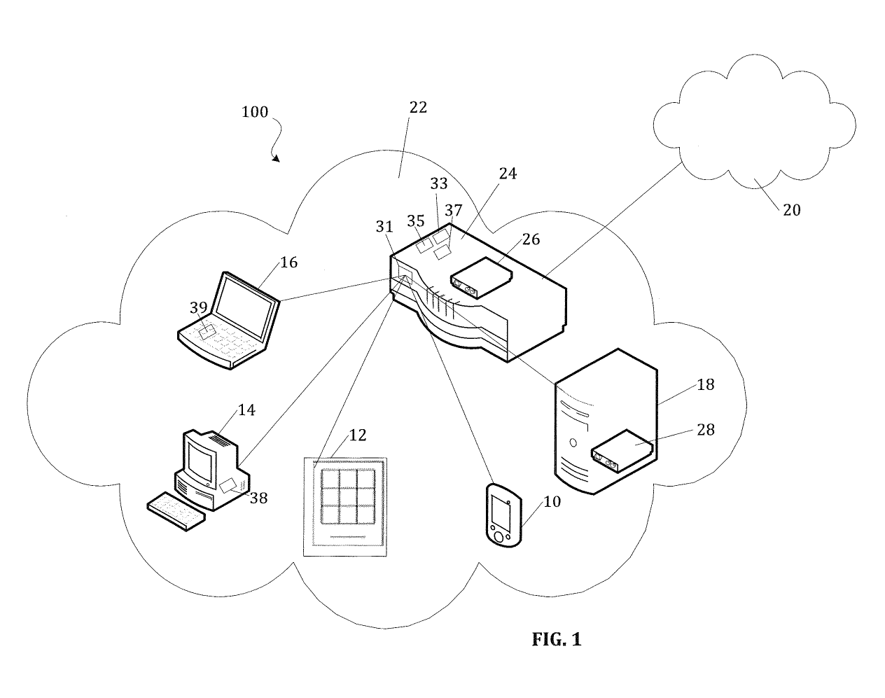

FIG. 1 depicts a system 100 for managing power use in an enterprise network 22. In one example embodiment, the enterprise network 22 includes a router 24, a server 18, a mobile telephone 10, a badge reader 12, a PC 14 and/or a laptop computer 16. The devices in the enterprise network 22 may be accessed and/or communicate with one another and/or other devices in the network via the router 24. The devices in the enterprise network 22 may also communicate with one or more devices in an external network 20 (e.g., the Internet and/or a different enterprise network) via the router 24. In one example embodiment, one or more of the enterprise network 22 devices such as router 24, server 18, mobile telephone 10, badge reader 12, PC 14 and/or laptop computer 16 may include sub-components. For example, router 24 may include one or more interfaces 31, at least one central processing unit (CPU) 33, local storage 35 and/or a power supply 37. In one example embodiment, the router 24 may include a monitor 26. The monitor 26 may be configured to monitor IP traffic flowing from one or more of the devices of the enterprise network 22 through the router 24. The monitor 26 may be configured to detect the IP traffic and use various packet analysis techniques to collect data about the IP traffic.

Packet analysis techniques may include deep-packet-inspection, IP traffic flow analysis and/or application detection. The monitor 26 may be configured to monitor local activity such as keystrokes and mouse clicks as well. In one example embodiment, the IP traffic data collected may identify the IP traffic source, time the IP traffic is sent, content, IP traffic destination, application running on a source device and/or a variety of other IP traffic related characteristics and claimed subject matter is not limited in this regard. Monitor 26 may be configured to monitor enterprise network 22 devices such as router 24, server 18, mobile telephone 10, badge reader 12, PC 14 and/or laptop computer 16 and/or sub-components thereof. For example, monitor 26 may monitor router 24, one or more interfaces 31, central processing unit (CPU) 33, local storage 35, power supply 37, other enterprise network 22 device and/or sub-components of the other network enterprise devices such as a CPU 38 on PC 14 and/or interface 39 on laptop computer 16.

In one example embodiment, the IP traffic data may be collected at the monitor 26 and sent to a policy manager 28 to be analyzed. The policy manager 28 may dynamically generate one or more power management policies and/or modify one or more existing power management policies based on the IP traffic data received. The policy manager 28 may be responsible for implementing power management policies as well including dynamic power management policies and/or modified existing power management policies. In some example embodiments, the IP traffic data may be analyzed and used to implement existing power management policies as well.

The policy manager 28 may be a standalone device in the enterprise network 22 or may reside in the server 18, the router 24 and/or in another network device. Claimed subject matter is not limited in this regard.

Monitoring IP traffic

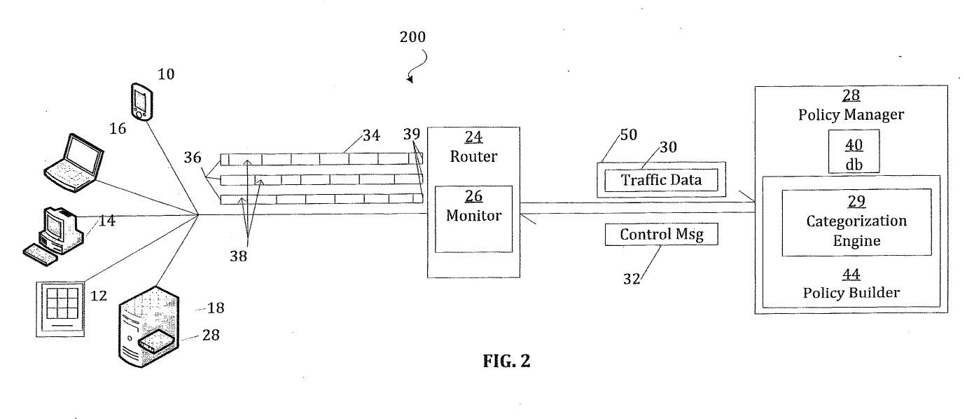

FIG. 2 is a block diagram illustrating an example embodiment of a method 200 for monitoring IP traffic. One or more devices, such as server 18, mobile telephone 10, badge reader 12, PC 14 and/or laptop computer 16 in enterprise network 22 may generate IP traffic 34. IP traffic 34 may flow to router 24. In one example embodiment, router 24 resides within enterprise network 22 (see FIG. 1, for example). In another example embodiment, router 24 may reside outside of enterprise network 22. Claimed subject matter is not limited in this regard.

At the router 24, the monitor 26 may passively monitor the IP traffic 34 using various passive monitoring techniques such as deep-packet-inspection, flow detection and/or application detection. Passive monitoring may be executed by processors running software programming such as Cisco's Network Based Application Recognition (NBAR™) and/or Cisco Flexible NetFlow®, for instance. Other passive or active monitoring programs and/or devices may be used by the monitor 26 and claimed subject matter is not limited in this regard. In another example embodiment, the monitor 26 may be a standalone device or may be co-located within another network device such as an access or aggregation switch or an edge router.

Passive monitoring may include tracking the IP traffic 34 and identifying one or more IP flows 36. The monitor 26 may observe the one or more IP flows 36 for a predetermined time period and/or may track the IP flows 36 based on other criteria such as session termination, for instance. In an example embodiment, each of the IP traffic flows 36 may comprise a series of packets 38 including a corresponding header packet 39. The IP flows 36 may be identified as a series of packets 38 that are part of the same connection and/or part of the same data transfer, such as in an Hypertext Transfer Protocol (HTTP) session or during a voice over IP call. In another example embodiment, the IP traffic 34 may be organized into one or more IP flows 36 according to one or more shared packet characteristics. Example packet characteristics may include one or more of the following: source, destination, source port, destination port, IP protocol and/or other identifiable packet characteristics known to those of skill in the art and claimed subject matter is not limited in this regard. In yet another example embodiment, the monitor 26 may be configured to track a time period during which a particular IP traffic flow 36 is transmitting.

In an example embodiment, monitor 26 may be configured to determine which applications are running on the network devices sending IP traffic 34 through router 24 by using an application recognition program such as, for example, Cisco's NBAR™ software. An application recognition program may be configured to analyze the packet content and/or the packet flow using deep-packet-inspection techniques, analyzing packet headers and/or packet payloads to determine the underlying application for a particular flow. A variety of other application recognition programs known to those of skill in the art may be used by monitor 26 to identify applications and claimed subject matter is not limited in this regard.

In an example embodiment, the monitor 26 may analyze the packets 38 to determine IP flow characteristics such as, for instance: version number, sequence number, input and output interface indices, flow start and finish time, packet size, number of packets, header data, protocol type, type of service, quality of service, routing information and/or so on. A variety of analytical techniques and tools may be used to analyze the packets 38 and claimed subject matter is not limited in this regard. For instance, flow analysis, application analysis and/or deep-packet-inspection may be used in combination with other IP traffic and/or packet analysis techniques to generate IP traffic data 30.

The monitor 26 may generate IP traffic data 30 in the form of a report 50. The report 50 may comprise identifying information for the one or more IP flows 36 in association with corresponding IP traffic data 30 and a corresponding network device. In one example embodiment, the monitor 26 may send the report 50 to a policy manager 28 for analysis by the policy builder 44. By at least analyzing the IP traffic data 30 from the report 50, the policy builder 44 may develop an overview of IP traffic flow patterns and IP traffic volume in the enterprise network 22. In an example embodiment, the policy builder 44 may determine which devices are critical and thus never to be subject to power management. By analyzing the IP traffic data 30, the policy builder 44 may determine when particular devices or respective sub-components of particular devices in the enterprise network 22 are not being used and/or if they are being put to an unauthorized use. The policy builder 44 may be configured for dynamically generating power management policies and/or modifying existing power management policies for the enterprise network 22 based on the observed IP traffic data 30 and may communicate the policies to the policy manager 28. Dynamic power management policies and/or modified existing power management policies may be implemented instantaneously for optimizing an enterprise's network power management practices.

Categorizing IP Traffic

Referring still to FIG. 2, the policy manager 28 may comprise a categorization engine 29. The categorization engine 29 may receive and analyze the IP traffic data 30 and sort the IP flows 36 according to defined IP traffic categories. The categorization engine 29 may communicate the IP traffic categories to the policy builder 44 to be used to generate the dynamic power management policies and/or modified existing power management policies.

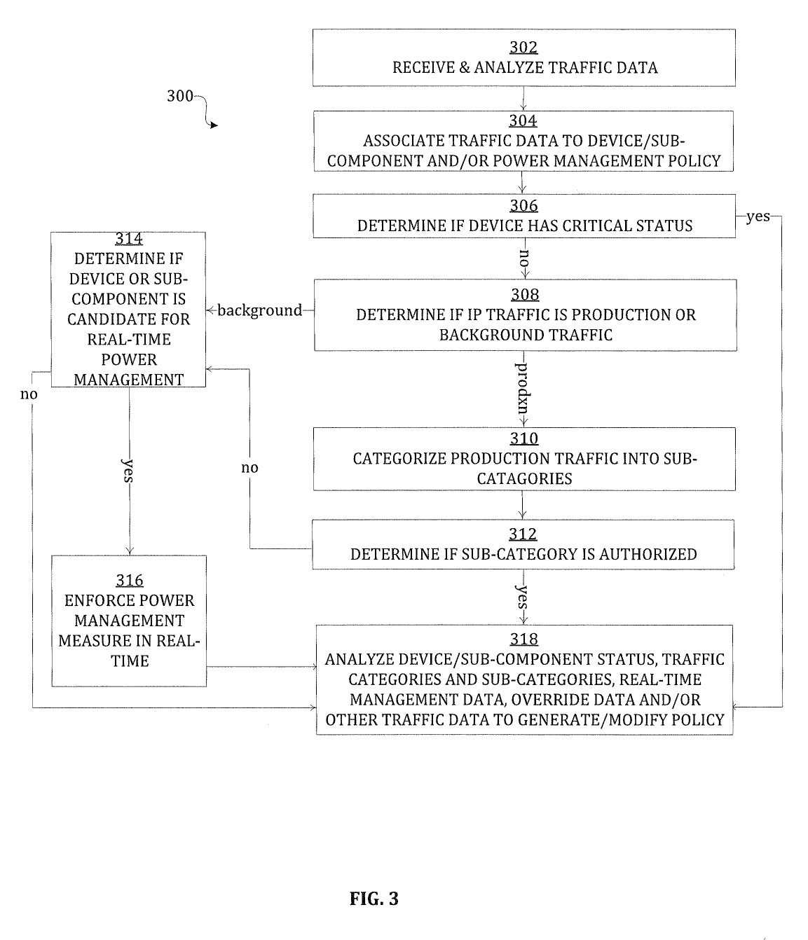

FIG. 3 is a flow diagram showing a process 300 for categorizing IP traffic data. Referring to both FIG. 2 and FIG. 3, in one example embodiment, at block 302, the policy builder 44 may be configured to receive and analyze IP traffic data 30 sent from the monitor 26.

At block 304, the policy builder 44 may access a database 40 to associate one or more network devices (e.g., laptop 16 and/or badge reader 10 in FIG. 1) and/or sub-components thereof with IP traffic data 30 corresponding to the network devices and/or sub-components thereof based on information in the IP traffic data 30. In one example embodiment, IP traffic data 30 corresponding to a particular network device and/or sub-components may include a source address, a user ID, and/or an IP flow 36 identity that may identify the particular network device in the database 40. The database 40 may additionally be configured for mapping the particular network device to dynamically generated power management policies and/or modified existing power management policies associated with the particular network device and/or sub-components thereof.

At block 306, the policy builder 44 may determine if the particular network device and/or sub-components thereof has critical status. If a network device's and/or sub-components thereof's status is ‘critical,’ the device may be one that performs a critical function for an enterprise or business and thus should be exempted from power management practices (e.g., powering down when idle). Critical functions may be pre-determined, identified dynamically and/or on a case-by-case basis and may include: authorization, emergency communications, back-up tasks, device/personnel authentication and/or security systems. There may be a variety of other functions classified as critical and claimed subject matter is not limited in this regard.

In one example embodiment, if a particular network device and/or sub-components thereof is determined to be critical, process 300 proceeds to block 318 where device status may be analyzed along with other IP traffic data to generate dynamic power management policies and/or modified existing power management policies. For example, a device's critical status may exempt the device from power management measures and may shape policies associated with different devices related to the particular network device and/or sub-components thereof having critical status, such as corresponding routers and switches.

If, however, the particular network device and/or sub-components thereof is not classified as a critical device then the particular network device and/or sub-components thereof may be a candidate for power management and process 300 may proceed to block 308. At block 308, the categorization engine 29 may determine if the IP traffic 34 corresponding to the particular network device and/or sub-components thereof is production IP traffic or background IP traffic based on IP traffic data 30.

Background IP traffic may indicate that the particular network device and/or sub-components thereof are idle, being used inefficiently and/or being used for an unauthorized purpose. In one example embodiment, background IP traffic may include IP traffic 34 that is continuous and/or intermittent whether or not the corresponding particular network device and/or sub-components thereof are being used for an authorized purpose either locally or remotely. The presence of background IP traffic may indicate that the corresponding particular network device and/or sub-components thereof are merely executing unnecessary or unauthorized background processes. For example, background IP traffic may include automatic email polling, Address Resolution Protocol (ARP) packets, Internet Control Message Protocol (ICMP) packets and/or generic Network Basic Input/Output (NetBIOS) requests. Background IP traffic may include a variety of other packet types and claimed subject matter is not limited in this regard. In another example embodiment, an absence of IP traffic over the course of a particular period of time and/or a pattern of silence may be treated as background IP traffic by the policy manager 28. Additionally and/or alternatively categorization engine 29 may be configured to leverage Class of Service (CoS) designations to categorize the IP traffic 34 and/or IP traffic flows 36 as background and/or production IP traffic.

In one example embodiment, if IP traffic data 30 indicates that the particular network device and/or sub-components thereof is currently transmitting background IP traffic, is silent or shown to exhibit a pattern of silence, process 300 may proceed to block 314. At block 314, the policy manager 28 may determine that the particular network device may be a candidate for real-time power management measures. Additionally and/or alternatively, a determination that a particular network device and/or sub-components thereof is a candidate for real-time power management may be based on IP traffic data 30 transmission time tracked by monitor 26 and/or a pattern of the background IP traffic.

The particular network device may be determined to be a candidate for real-time power management based on predetermined device parameters and/or device parameters input by a user such as a network administrator. For example, one or more network devices may be identified in a listing stored in the database 40 as candidates for real-time power management. In one example embodiment, whether a particular network device and/or sub-components thereof is a candidate for real-time power management may depend on the type of background IP traffic transmitting from the device and/or whether the device is silent or exhibiting patterns of silence.

If the particular network device and/or sub-components thereof is determined to be a candidate for real-time power management, process 300 may move to block 316. At block 316, the policy builder 44 may generate a real-time power management policy. The policy manager 28 may enforce the real-time power management policy by applying the real-time power management measures to the particular network device. In an example embodiment, policy manager 28 may send a power management command to the particular network device to go into a low or no power state or the like. Process 300 may then proceed to block 318 where real-time power management data may be analyzed and/or used by the policy builder 44 to generate dynamic power management policies and/or modified existing power management policies. For example, IP traffic data 30 indicating that the particular network device and/or sub-components thereof is silent due to power management measure enforcement may impact dynamic power management policy development differently than if the particular network device and/or sub-components thereof is silent without intervention by the power management policy manager 28.

Returning to block 308, IP traffic 34 associated with the particular network device may be production IP traffic. Production IP traffic may indicate that the particular network device and/or sub-components thereof is engaged for or being used for an authorized purpose and/or the particular network device and/or sub-components thereof is being used efficiently. In one example embodiment, production IP traffic may include IP traffic 34 that is generated when a user is downloading one or more web pages, sending email, conducting a Voice over IP call, engaging in an active instant messaging conversation, working on authorized applications locally and/or participating in a WebEx session.

In one example embodiment, if the IP traffic 34 is determined to be production IP traffic, the process may proceed to block 310 where the production IP traffic may be further categorized into sub-categories. Sub-categories of production IP traffic may be detected using various packet and flow analytics such as DPI and/or flow analysis. The monitor 26 may be configured to detect local use (e.g., simply hitting a key on keyboard) and network use (e.g., accessing a resource over the enterprise network 22). Local use and network use may both indicate usage but may be monitored in different ways. Network use may be monitored with various programs for executing packet and flow analytics. For instance, monitor 26 may be configured with Cisco NetFlow™ for flow analysis and/or Cisco NBAR™ for application analysis. Local activity on a particular network device such as keystrokes and mouse clicks may also be detected by the monitor 26 using, for example, an embedded software agent. These various analytical tools may be used by the monitor 26 to detect local use and network activity on a particular network device. Network activity and local device use may be communicated to policy manager 28 in the report 50 including IP traffic data 30 to be analyzed by the policy builder 44. A variety of other uses or activities may be may be detected using a variety of other and/or additional packet inspection methods and/or device activity detectors known to those of skill in the art. Claimed subject matter is not limited in this regard.

In one example embodiment, production IP traffic may be sorted into one or more of the following categories:

Heavy IP traffic: Heavy IP traffic may include backup processes, video streaming and/or file downloading. Heavy IP traffic types may be heavy bandwidth consumers. Heavy IP traffic may be detected with IP traffic flow analysis. A power management policy may exclude devices sending or receiving heavy IP traffic. The network power management policy may include categorizing the heavy IP traffic further to determine whether or not the particular network device and/or sub-components thereof is a candidate for power management. Heavy IP traffic may be an authorized sub-category of IP traffic 34. In another example embodiment, heavy IP traffic may be a candidate for power management where the particular network deice is generating unauthorized/non-business traffic such as downloading music and /or videos.

Business IP traffic: Business IP traffic may be identified as production IP traffic including indications that the endpoint is executing and/or being used for a business activity. Business activities may be pre-determined or determined on a case-by-case basis by a network administrator. Production IP traffic may be categorized as business IP traffic if the production IP traffic appears to be associated with business activities such as: accessing various network databases, visiting social networking sites (e.g., by marketing personnel), conducting Voice over IP telephone calls, engaging in an active instant messaging conversation, videoconferencing and/or participating in an Internet meeting (e.g., WebEx sessions). Business IP traffic may be an authorized sub-category of IP traffic 34.

Critical IP traffic: Some production IP traffic may be enterprise or business critical. Production and/or background IP traffic that is associated with certain devices, services and/or activities may be classified as critical. Devices associated with critical IP traffic may be exempt from power management measures. Critical IP traffic may be an authorized sub-category of IP traffic 34.

Management IP traffic: Certain production IP traffic may be idiosyncratic of management IP traffic and may be considered authorized IP traffic for power management purposes and thus not subject to power management measures. Management IP traffic may be an authorized sub-category of IP traffic 34.

Unauthorized IP traffic: Production IP traffic that is explicitly unauthorized or unexpected in association with particular network devices or during identified times of day may be considered unauthorized IP traffic. Authorized vs. unauthorized IP traffic may be pre-set and/or customized by network administrators and/or other users.

In one example embodiment, the categorization engine 29 may be configured to be customized by a network administrator to tailor definitions for various categories and sub-categories of IP traffic 34. In other words, what constitutes business IP traffic or critical IP traffic in an enterprise network may be defined by the network administrator. A network administrator may add IP traffic categories as appropriate.

In one embodiment, various identified categories of IP traffic 34 may be used to analyze and determine IP traffic patterns for the particular network device. The IP traffic patterns may show when devices and/or sub-components thereof are most often being put to productive use and when the network devices are not being used or are being used for an unauthorized purpose. In one embodiment, the IP traffic patterns may be used to dynamically generate power management policies and/or modify existing power management policies. In some embodiments, the dynamic power management policies and/or modified power management policies may track IP traffic patterns in real-time based on real-time IP traffic pattern recognition. Categorization of IP traffic may also be used to modify and implement existing power management policies.

In one example embodiment, categorizing production IP traffic into sub-categories may provide the policy manager 28 additional data with which to implement existing power management policies. Sub-categorization of production IP traffic may provide additional data to the policy builder 44 to determine IP traffic patterns to a finer granularity for use in dynamic power management policy generation and/or modifying existing power management policies. For example, if IP traffic 34 is determined to be production IP traffic this may merely indicate that a particular network device and/or sub-components thereof are actually being used. However, certain network device uses may be limited and/or prohibited according to network management policies already in place. Sub-categorization of production IP traffic may identify unauthorized categories of production IP traffic that may be treated as background IP traffic and/or may be communicated to the policy builder 44 to be used in identifying IP traffic patterns for unauthorized uses of network devices.

Policy builder 44 may analyze the sub-categories of production IP traffic to further determine whether the particular network device and/or sub-components thereof are a candidate for real-time power management because the production IP traffic is unauthorized and/or undesirable and may be treated as background IP traffic. At block 312, if a sub-category of IP traffic 34 is determined to be unauthorized and/or undesirable the process 300 proceeds back to block 314 and continues from there as discussed above. However, if the sub-category is authorized, process 300 proceeds to block 318 where production IP traffic categories and sub-categories analyzed and/or used by the policy builder 44 to generate dynamic power management policies and/or modified existing power management policies. For example, network managers may customize dynamic power management policy parameters based on the sub-category of production IP traffic wherein, for instance, some sub-categories of production IP traffic may be subject to dynamic power management policies without authorization by a network manager. At block 318, the policy builder may analyze available IP traffic related data corresponding to the particular device to generate dynamic power management policies and/or modified existing power management policies. The available IP traffic related data may include device status, traffic categories and sub-categories, real-time management data, override data and/or other traffic data.

Generating Power Management Policies

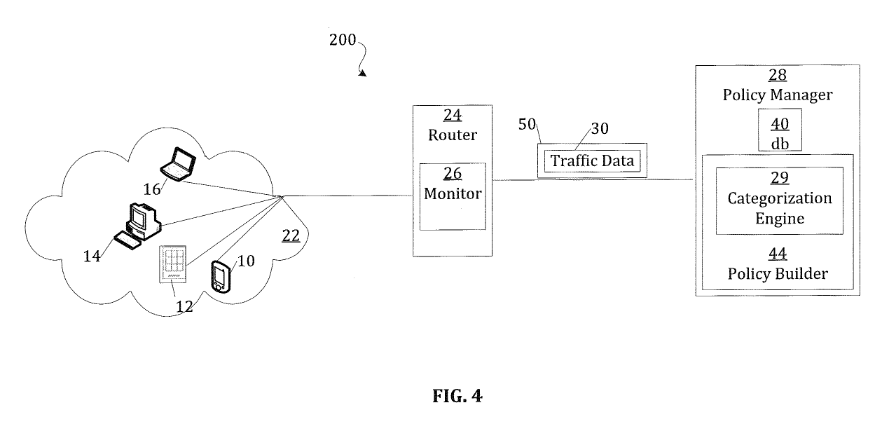

FIG. 4 depicts an example embodiment of a system 200 for power management in an enterprise network 22. System 200 may include the policy manager 28 comprising the policy builder 44. The policy builder 44 may be configured to develop one or more IP traffic profiles associated with one or more network devices (e.g., the router 24, the server 18, the mobile telephone 10, the badge reader 12, the PC 14 and/or the laptop computer 16) or device sub-components based on the IP traffic data 30 and other traffic related data including IP traffic categories and IP traffic sub-categories, device status, whether a device is subject to real-time power management measures and/or the like. The IP traffic profiles may identify one or more IP traffic patterns associated with one or more network devices or sub-components of the network devices. The IP traffic patterns may indicate when and/or if an associated device or device sub-component is a candidate for power management measures. The IP traffic profiles may be characterized by one or more spikes on a graph, a standard histogram and/or other methods of graphically representing an IP traffic analysis. The IP traffic profiles may identify opportunities to implement power management measures, for instance, by showing when network devices are typically inactive or silent, transmitting only background IP traffic, transmitting unauthorized IP traffic and the like, or combinations thereof.

In an example embodiment, the policy builder 44 may be configured to dynamically build one or more power management policies that may, for instance, prevent idle and/or unproductive devices in a network from consuming power. The policy builder 44 may analyze IP traffic patterns, IP traffic data and/or other IP traffic related data to generate the one or more dynamic power management policies based on the IP traffic patterns, IP traffic data and/or other IP traffic related data. Additionally and/or alternatively, the policy builder 44 may be configured to modify existing power management policies based on the IP traffic patterns, IP traffic data and/or other IP traffic related data. The dynamic power management policies and/or modified existing power management policies may be applied to the enterprise network 22 automatically or may be applied upon approval of a user such as a network administrator. The policy builder 44 may access a database 40 to store the dynamic power management policies and/or modified existing power management policies in association with a corresponding network device (e.g. the router 24),a group of network devices (e.g., the router 24, the server 18, the mobile telephone 10, the badge reader 12, the PC 14 and/or the laptop computer 16) and/or one or more sub-components of one or more network devices.

In an example embodiment, the policy manager 28 may be configured for implementing existing power management policies as well as the dynamic power management policies and/or modified existing power management policies. The policy manager 28 may be configured to receive one or more reports 50 periodically or continuously from another network entity (e.g., the router 24) and may communicate the one or more reports 50 and other IP traffic related data to the policy builder 44 for analysis.

The dynamic power management policies and/or modified existing power management policies generated by the policy builder 44 may include an override function in the event that a user wishes to use one of the network devices subject to power management measures. The override function may be executed automatically when activity is detected on a particular device or may be manual such as an override keystroke or mouse click. In another example embodiment, an override signal from any of the network devices in enterprise network 22 may awaken the router 24 if router 24 was in a low or no power state.

If the IP traffic data 30 and/or the other IP traffic related data indicate that a network device and/or sub-components thereof are frequently subject to override, the override data may be compensated for by modifying or generating future power management policies corresponding to the affected device that may prevent the inconvenience of requiring a user to execute an override function frequently. For example, the policy builder 44 may modify the corresponding power management policy by exempting network devices subject to frequent override from power management measures.

In an example embodiment, IP traffic data 30 and/or the other IP traffic related data may be received as updates by the policy builder 44 on a continuous basis. IP traffic patterns identified by the policy builder 44 may be updated accordingly. IP traffic patterns may be shown to shift over time as the activity on corresponding network devices (e.g., the router 24, the server 18, the mobile telephone 10, the badge reader 12, the PC 14 and/or the laptop computer 16) changes. Responsive to updating the IP traffic patterns, the policy builder may dynamically power management policies and/or modify existing power management policies. The updated power management policies may be automatically implemented or vetted prior to implementation by a network administrator.

Enforcing Power Management Policies

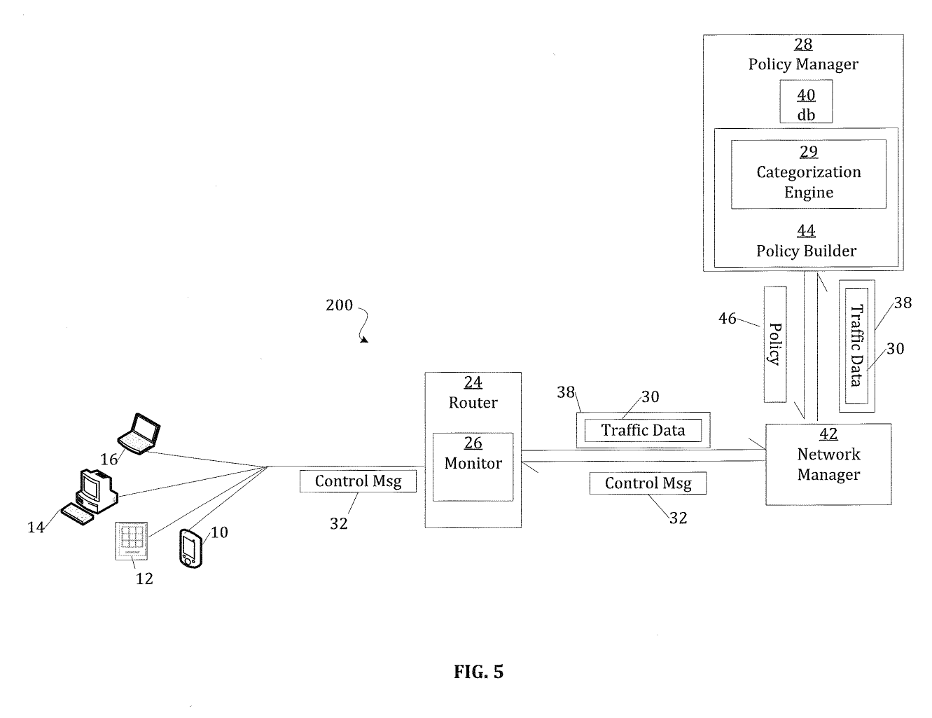

FIG. 5 depicts a system 200 for managing power use in an enterprise network 22 (e.g., see FIG. 1). In an example embodiment, power management policy 46 may comprise dynamic power management policies and/or modified existing power management policies. The dynamic power management policies and/or modified existing power management policies may be associated with corresponding network devices and/or sub-components thereof in database 40. The power management policy 46 may be enforced by the policy manager 28 and/or the network manager 42 against one or more target devices and/or sub-components thereof. A target device and/or sub-components thereof may comprise a network device and/or sub-components thereof that is the subject or target of a power management measure that may be implemented according to power management policy. Power management policy enforcement may comprise accessing database 40 to determine which devices and/or sub-components thereof are targets associated with the policy 46 and sending a set of instructions in a control message 32 to one or more target devices and/or sub-components thereof for power management responsive to the power management policy 46. The control message 32 may include instructions to put the one or more target devices and/or sub-components thereof into a low-power or off state. The control message 32 may comprise instructions to implement other power consumption reducing measures know to those of skill in the art and claimed subject matter is not limited in this regard. The control message 32 may be sent and/or executed using a variety of methods and technologies known to those of skill in the art and claimed subject matter is not limited in this regard.

In one example embodiment, policy manager 28 may oversee policy management of a single target device (e.g., the router 24), a group of target devices (e.g., the router 24, the server 18, the mobile telephone 10, the badge reader 12, the PC 14 and/or the laptop computer 16) and/or one or more subcomponents of one or more target device. The group of target devices and/or sub-components thereof may not be logically connected. If the group of target devices is not logically connected, the policy manager 28 may send a control message 32 to each of the devices and/or sub-components thereof in the group of target devices.

In another example embodiment the policy manager 28 may identify IP traffic flows corresponding to the target devices of a group and/or sub-components thereof and correlate the target devices of the group and/or sub-components thereof in a logical path. A logical path may include network devices having one or more common characteristics, such as, all of the network devices through which an end user connects to the enterprise network 22. The policy manager 28 may determine that certain of the target devices and/or sub-components thereof in the logical path may be managed at a port level to implement power management measures. For example, a router or switch may be subject to power management measures where all devices and/or sub-components thereof coupled to the router or switch are also subject to power management measures. However, the router or switch may be exempt from power management measures where the router or switch is coupled to one or more non-target network devices and/or sub-components thereof.

In one embodiment, the policy 46 may be configured to manage the group of target devices and/or sub-components thereof that are connected logically in a path or sequence. The control message 32 may include instructions for implementing power management measures along the path or sequence of the group of target devices and/or sub-components thereof. For example, if the group of target devices and/or sub-components thereof are all connected to the same trunk device, policy manager 28 may send one control messages 32 to instruct each of the connected target devices and/or sub-components thereof and the trunk device to implement power management measures. A policy manager 28 may connect to the network devices associated with a logical path using standard management interfaces including, Command Line Interface (CLI), Application Programming Interface (API), Simple Network Management Protocol (SNMP) and/or the like.

For example, the policy builder 44 may identify an IP traffic pattern showing that, for example, after a certain time of day across one or more departments in the enterprise network 22, there is little or no voice IP traffic. Based on this observation the policy builder 44 may generate the policy 46 indicating that IP phones are the target devices and to be logically connected in sequence. The policy 46 may indicate that the target devices are to power off during observed quiet periods. The policy 46 may be communicated to the policy manager 28. The policy manager 28 may logically connect the corresponding IP phones in enterprise network 22 responsive to the policy 46. The policy manager 28 may communicate the policy 46 to the network manager 42. The network manager 42 may generate the control message 32 to be communicated to the identified and logically connected IP phones to implement to power management measures identified in the policy 46. The policy manager 28 may send the policy 46 to the network manager 42 or may directly implement the policy 46 without administration by the network manager 42 and/or approval of a network administrator. In one example embodiment, the policy manager 28 may be incorporated in the network manager 42.

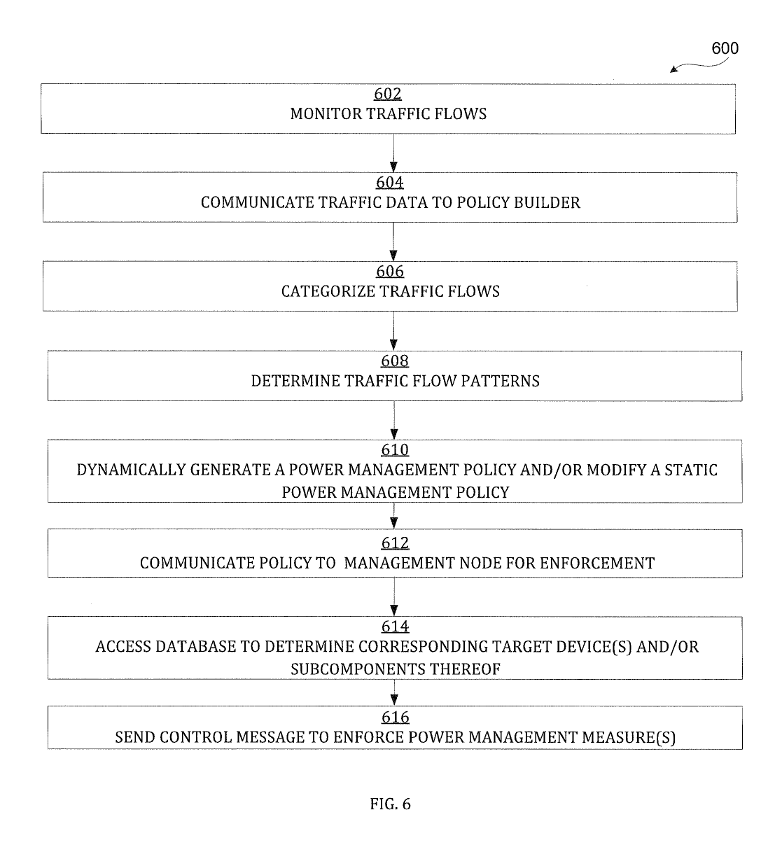

FIG. 6 is a flow diagram showing a process 600 for generating a dynamic power management policy and/or modifying an existing power management policy. The process 600 begins at block 602, where an IP traffic monitor passively and/or actively monitors network IP traffic. The monitor may generate IP traffic data identifying one or more IP traffic flows and/or other IP traffic characteristics. The monitoring may include deep-packet-inspection, Cisco NBAR™, EnergyWise®, and/or various other packet level monitoring techniques. At block 604, IP traffic data may be communicated to a policy builder.

At block 606, the policy builder may analyze the IP traffic data to categorize the IP traffic flows. In one example embodiment, IP traffic flow authorization may be based on the IP traffic flow category. Wherein, authorized and/or unauthorized categories of IP traffic flows may be pre-determined and/or defined, refined and/or customized by a network administrator.

At block 608, the policy builder may analyze IP traffic flow behavior to determine IP traffic flow patterns for one or more IP traffic flows identified in the IP traffic data. The analysis may be based on the IP traffic data communicated from the monitor, IP traffic categories and/or associated historical IP traffic data archived in memory in the policy builder including device criticality, whether a device is subject to real-time power management measures, whether a device is subject to power management override and/or the like.

At block 610, the policy builder may dynamically generate a power management policy and/or modify an existing power management policy based on the analysis.

At block 612, the policy builder may communicate the dynamically generated power management policy and/or the modified existing power management policy to a policy and/or network manager to be implemented. In one example embodiment, dynamically generated power management policy and/or the modified existing power management policy may be implemented automatically. In another example embodiment, dynamically generated power management policy and/or the modified existing power management policy may be implemented only after approval by a network administrator. In yet another example embodiment, parameters may be established within which the dynamically generated power management policy and/or the modified existing power management policy may be implemented automatically and need not be approved. The parameters may be set by the network administrator and may include time limits, limit automatic implementations to certain devices in the network and the like. In one example embodiment, whether the policy requires approval of a network administrator prior to implementation may be based on a variety of factors such as the number and type of devices affected by the power management policy and the length of time the power management policy will affect the devices.

At block 614, the policy and/or network manager may access database 40 to determine which devices are target devices and/or target sub-components associated with the dynamically generated power management policy and/or the modified existing power management policy. At block 616 the policy and/or network manager may send a set of instructions in a control message 32 to one or more identified target devices and/or sub-components thereof to implement power management measures against the one or more identified target devices responsive the dynamically generated power management policy and/or the modified existing power management policy.

Many modifications and other embodiments of the disclosed technology will come to mind to those skilled in the art to which this disclosed technology pertains having the benefit of the teachings presented in the foregoing descriptions and the associated drawings. Therefore, it is to be understood that the disclosed technology is not to be limited to the specific embodiments disclosed and that modifications and other embodiments are intended to be included within the scope of the appended claims. Although specific terms are employed herein, there are used in a generic and descriptive sense only and not for purposes of limitation. It will be obvious to those having skill in the art that many changes may be made to the details of the above-described embodiments without departing from the underlying principles of the disclosed technology. The scope of the present disclosed technology should, therefore, be determined only by the following claims.

What is claimed is:

1. A method, comprising:
receiving Internet Protocol (IP) traffic data corresponding to one or more network devices;
analyzing the IP traffic data;
identifying one or more IP traffic flows corresponding to the one or more network devices based on the analysis;
categorizing the one or more IP traffic flows into one or more IP traffic categories;
associating the one or more network devices with corresponding ones of the one or more categorized IP traffic flows; and
dynamically generating a power management policy based on the categorized IP traffic flows.

2. The method of claim 1, further comprising;
sending a control message to the one or more network devices to manage power consumption by the one or more network devices based on the dynamic power management policy.

3. The method of claim 1, further comprising:
classifying one of the one or more network devices as critical; and
exempting the critical network device from power management measures based on the dynamic power management policy wherein the dynamically generated power management policy applies to one or more non-business critical network devices.

4. The method of claim 1, further comprising identifying an IP traffic flow pattern corresponding to the one or more network devices wherein the IP traffic flow pattern is associated with at least one of the one or more IP traffic categories, wherein the dynamically generated power management policy is based on the IP traffic flow pattern.

5. The method of claim 2, wherein the control message instructs the one or more network devices to go into a power saving mode for a specified period of time.

6. The method of claim 5, wherein the control message includes an override instruction for restoring power to the one or more network devices in the power saving mode.

7. The method of claim 5, wherein the power saving mode is a low-power or off state.

8. An apparatus, comprising:
one or more processors; and
a memory coupled to the processors comprising instructions executable by the processors, the processors configured when executing the instructions to:
receive Internet Protocol (IP) traffic data corresponding to one or more network devices;
identify one or more sub-components of the one or more network devices corresponding to the IP traffic;
analyze the IP traffic data;
identify traffic patterns of one or more IP traffic flows corresponding to the one or more network device sub-components devices based on the analysis; and
generate a power management policy based on the traffic patterns.

9. The apparatus of claim 8, wherein the IP traffic data comprises data corresponding at least one of the following: deep packet inspection of a particular IP traffic flow, remote device activity and remote application use.

10. The apparatus of claim 8, wherein the power management policy is a dynamically generated new power management policy or a modified existing power management policy.

11. The apparatus of claim 8, wherein the power management policy is further based on categories of IP traffic flows.

12. The apparatus of claim 9, wherein the power management policy corresponds to a single target device or single sub-component of a network device.

13. The apparatus of claim 12, wherein the power management policy corresponds to a group of logically connected sub-components of the one or more network devices.

14. The apparatus of claim 12, wherein the power saving mode is a low-power or off state.

15. One or more computer readable storage media encoded with software comprising computer executable instructions and when the software is executed operable to:
receive Internet Protocol (IP) IP traffic data corresponding to one or more network devices;
analyze the IP traffic data; and
dynamically generate a power management policy based on the analysis.

16. The computer readable storage media encoded with software of claim 15, the software when executed further operable to:
categorize the IP traffic flows as authorized or unauthorized; and
send a control message to a network device corresponding to an unauthorized IP traffic flow including instruction to go into power saving mode.

17. The computer readable storage media encoded with software of claim 16, wherein the control message is sent in real-time.

18. The computer readable storage media encoded with software of claim 15, the software when executed further operable to:
Identify and categorize one or more IP traffic flows corresponding to the one or more network devices into one or more IP traffic categories based on the IP traffic data wherein the dynamically generated power management policy is based on the IP traffic categories.

19. The computer readable storage media encoded with software of claim 16, wherein the control message instructs the one or more network devices to go into a power saving mode for a specified period of time.

20. The computer readable storage media encoded with software of claim 19, wherein the control message includes an override instruction for restoring power to the one or more network devices in power saving mode.
